(19) United States
(12) Patent Application Publication
(10) Pub. No.: US 2024/0143781 A1
(43) Pub. Date: May 2, 2024

(54) SYSTEMS, DEVICES, AND METHODS FOR ANALYZING RANSOMWARE THREAT INTELLIGENCE

(71) Applicant: SAUDI ARABIAN OIL COMPANY, Dhahran (SA)

(72) Inventors: Mariam Fahad BUBSHAIT, Dhahran (SA); Sultan Saadaldean ALSHARIF, Dammam (SA); Abdullah ALTURAIFI, Dhahran (SA)

(73) Assignee: SAUDI ARABIAN OIL COMPANY, Dhahran (SA)

(21) Appl. No.: 18/051,790

(22) Filed: Nov. 1, 2022

(51) Int. Cl. G06F 21/57; G06F 21/55

(52) U.S. Cl. CPC G06F 21/577; G06F 21/552; G06F 2221/033

(57) ABSTRACT

A security tool includes a vulnerability classifier for classifying vulnerabilities based on an assessment report, an exploitability classifier for determining an exploitability level for a vulnerability of a list of vulnerabilities of the assessment report based on data of an intelligence feed, a risk classifier for calculating an overall risk level for a computer application associated with the vulnerability of the list of vulnerabilities based on an impact score for the computer application, and a remediation prioritizer to determine an order of remediation for the computer application and to generate a remediation prioritization report including the order of remediation.

### FIELD OF THE DISCLOSURE

The present description relates generally to ransomware threat mitigation and, more particularly, to systems and methods for analyzing ransomware threat intelligence.

### BACKGROUND OF THE DISCLOSURE

Ransomware threat intelligence refers to information mined from security testing performed on a computer application to determine whether the computer application includes vulnerabilities exploitable by malicious ransomware programs. Ransomware is malware that exploits vulnerabilities in computer applications to maliciously encrypt information for ransom. Ransomware is often designed to spread across one or more systems and/or a network, targeting databases, file servers, and other computer applications, and thus potentially preventing an organization from accessing system resources.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the purpose of this summary is to present some concepts of the disclosure in a simplified form prior to the more detailed description that is presented hereinafter.

According to an embodiment of the present disclosure, a security tool includes a vulnerability classifier for classifying vulnerabilities based on an assessment report, an exploitability classifier for determining an exploitability level for a vulnerability of a list of vulnerabilities of the assessment report based on data of an intelligence feed, a risk classifier for calculating an overall risk level for a computer application associated with the vulnerability of the list of vulnerabilities based on an impact score for the computer application, and a remediation prioritizer to determine an order of remediation for the computer application and to generate a remediation prioritization report including the order of remediation.

In another embodiment of the present disclosure, a method includes classifying vulnerabilities based on an assessment report, determining an exploitability level for a vulnerability of a list of vulnerabilities based on data of an intelligence feed, calculating an overall risk level for a computer application associated with the vulnerability of the list of vulnerabilities based on an impact score for the computer application, determining an order of remediation for the computer application, and generating a remediation prioritization report including the order of remediation for the computer application.

Any combinations of the various embodiments and implementations described herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a system for analyzing ransomware threat intelligence in accordance with certain embodiments.

FIG. 2 is a block diagram of a system for training one or more machine learning models in

accordance with certain embodiments.

FIG. 3 is a flow diagram of a method for analyzing ransomware threat intelligence in accordance with certain embodiments.

FIG. 4 is a block diagram of a computer system that can be employed to execute a system for analyzing ransomware threat intelligence in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments described herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to ransomware threat mitigation and, more particularly, to systems and methods for analyzing ransomware threat intelligence. Early detection of ransomware threats can mitigate or reduce an amount of damage that such threats cause to one or more systems or a network to which the one or more systems are coupled. Ransomware threat intelligence enables proactive responses to ransomware threats before these threats compromise the one or more systems.

It should be noted that while the threats being addressed by systems and methods herein are characterized as ransomware, other malware threats generally, including other types of cyber threats and attacks, are of concern and intended to be addressed by the systems and methods described herein.

An embodiment in accordance with the present disclosure describes a method for analyzing ransomware threat intelligence to determine a risk level of one or more computer applications and generating a report that prioritizes the one or more computer applications in terms of remediation urgency. This method obtains data sets from different sources including results of security testing of computer applications, exploitability level for one or more vulnerabilities associated with the one or more computer applications, threat intelligence data feeds, impact scores related to organization specific criteria, or a combination thereof. The results of the security testing of the computer applications are generated by an application scanner (a security testing tool). The exploitability level indicates whether a vulnerability associated with a computer application is exploitable. A vulnerability, as used herein, refers to a flaw within a computer application that makes the computer application susceptible to a ransomware or other type of cyber attack or malware. Threat intelligence data feeds may include both internal feeds (i.e. from within an organization) and external feeds (i.e. from defined threats recognized by a global community). Impact score related to organization specific criteria may include, but are not limited to, parameters related to integrity, availability, confidentiality, other variables used by the organization, or and a combination thereof. Considering these data sources in determining the risk level enhances the accuracy of the generated report that prioritizes remediation of the organization's computer applications and their associated vulnerabilities in order to prevent ransomware or other attacks. Timely prioritization and remediation of vulnerabilities before they are utilized by malicious third parties to perform a ransomware attack enables increased utilization of the organization's system resources, which include networks, computer applications, and other associated system components, and reduces costs associated with mitigating damage done by ransomware attacks.

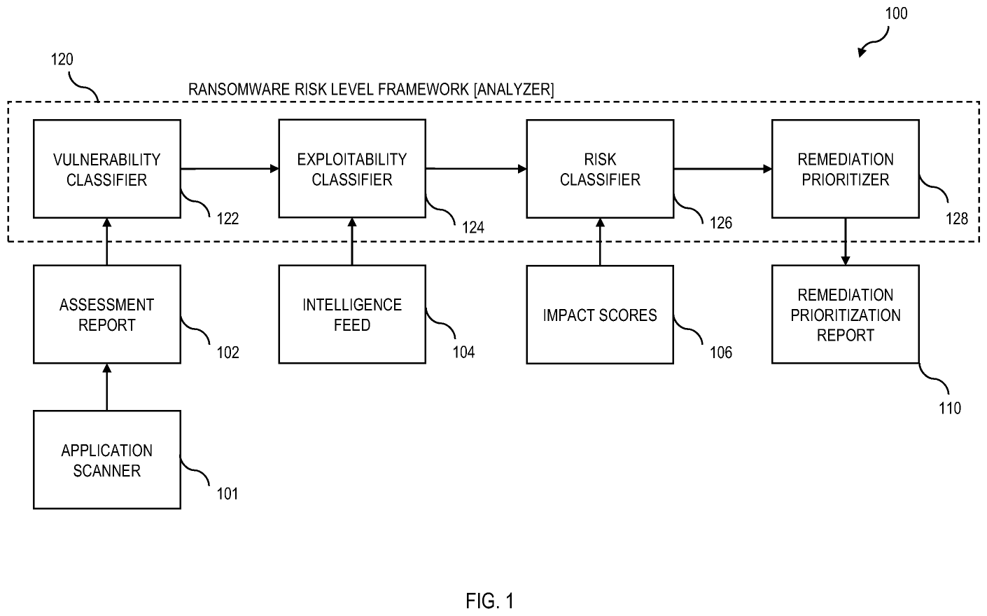

FIG. 1 is a block diagram of a system 100 for analyzing ransomware threat intelligence in accordance with certain embodiments. In a non-limiting example, system 100 is a security tool that includes an analyzer 120 for analyzing ransomware threat intelligence. Using data from sources such as an assessment report, an intelligence feed, and/or one or more impact scores, and the like, the analyzer 120 can classify vulnerabilities associated with one or more computer applications, determine exploitability levels for the vulnerabilities, calculate an overall risk level for each of the one or more computer applications, determine an order of remediation for the one or more computer applications, and generate a remediation prioritization report that includes the order of remediation for the one or more computer applications.

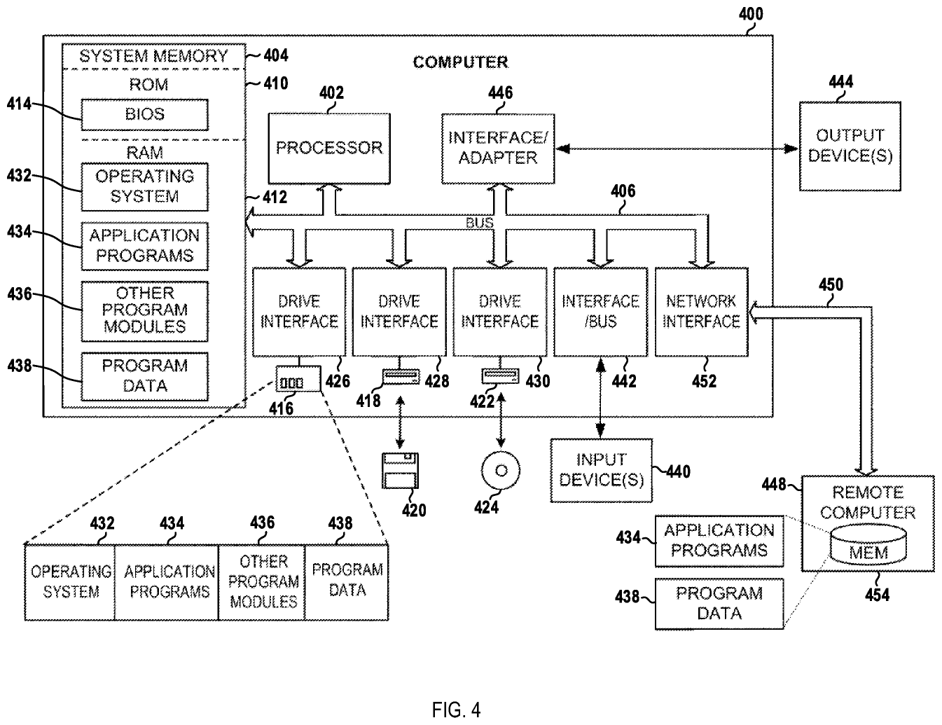

In a non-limiting example, one or more of the assessment report 102, the intelligence feed 104, or the one or more impact scores 106 is retrieved by the analyzer 120 from a computer-readable media, as described below with respect to FIG. 4. In another non-limiting example, one or more of the assessment report 102, the intelligence feed 104, or the one or more impact scores is received by the analyzer 120 via an input device or via a network interface, as described below with respect to FIG. 4.

The assessment report 102 includes data generated by the application scanner 101, which analyzes one or more computer applications for security vulnerabilities. The intelligence feed 104 includes ransomware threat intelligence data, which may include an internal threat data intelligence feed, an external threat data intelligence feed, or a combination thereof. The intelligence feed 104 may comprise one or more feeds or streams of data. The impact scores 106 include organization specific criteria provided by the organization for evaluating the priority of computer applications used by the organization. One or more of the assessment report 102, the intelligence feed 104, and the impact scores 106 may be herein referred to as ransomware threat intelligence. The remediation prioritization report 110 is an output of the analyzer 120 and includes at least one of an overall risk level and/or an order of remediation for a specified computer application.

Within the analyzer 120, in a non-limiting example, a vulnerability classifier 122 of the analyzer 120 categorizes and/or classifies vulnerabilities associated with one or more computer applications based on the data of the assessment report 102 and generates a list of vulnerabilities for the one or more computer applications. One or more vulnerabilities may be associated with a computer application. An exploitability classifier 124 of the analyzer 120 receives the list of vulnerabilities from the vulnerability classifier 122 and the intelligence feed 104. Using data of the intelligence feed 104, the exploitability classifier 124 determines an exploitability level of a vulnerability of the list of vulnerabilities. In a non-limiting example, the exploitability classifier 124 analyzes, using one or more machine learning models, the vulnerability of the list of vulnerabilities to determine whether the vulnerability includes one or more commonalities with the data of the intelligence feed, and generates the exploitability level based on a result of the determination. A risk classifier 126 of the analyzer 120 receives the exploitability level from the exploitability classifier 124 and the impact scores 106 and determines a risk level for a vulnerability of a specified computer application, for the specified computer application as a whole (i.e. an computer application overall risk level), or a combination thereof. The remediation prioritizer 128 determines an order of remediation (i.e. remediation priority) for one or more computer applications based on each computer application's overall risk level. The remediation prioritizer 128 generates the remediation prioritization report 110 for one or more computer applications that includes the order of remediation.

In accordance with certain embodiments, a computer application security assessment is performed by application scanner 101 for a computer application deployed in an organization. The computer application security assessment may be performed prior to use of the computer application within the organization, in response to an update to the computer application, or as part of a security testing schedule determined by the organization. The computer application security assessment tests the computer applications using application scanner 101 that detects security vulnerabilities and generates the assessment report 102. The assessment report 102 may include rankings and classifications of the vulnerabilities based on data of one or more vulnerability databases, such as Common Vulnerability and Exposures (CVE) and Common Vulnerabilities Scoring System (CVSS). The data of the one or more vulnerability databases includes rankings that provide a severity score that reflects a severity of a vulnerability. This severity score may be a numerical representation, a qualitative representation (e.g., low, medium, high, and critical), or a combination thereof. The security testing tool may identify if the vulnerability allows for remote code execution (RCE) by providing a remote code execution indicator. The security testing tool may identify if the vulnerability allows for privilege escalation (PE) by providing a privilege escalation indicator. The assessment report 102 may include, but is not limited to, vulnerability identification information (e.g. CVE identifier), the severity score, rankings and classifications based on CVSS and/or CVE, an indication of whether one or more of remote code execution and/or privilege escalation are enabled (e.g., RCE/PE indicator(s)), are all compiled in an assessment report (i.e. a security testing report) which is provided to the analyzer 120. In certain embodiments, one or more pieces of data of the assessment report 102 is included in the remediation prioritization report 110.

A non-limiting example of the assessment report 102 is provided in Table 1 below.

TABLE 1

| Computer | Vulnerability | Severity | | |
|---|---|---|---|---|
| Application | Identifier | Score | RCE/PE | Severity |
| Sales | CVE-2010-3782 | 8.8 | No | High |
| | CVE-2016-3990 | 9.9 | No | Critical |
| HR | CVE-2013-1420 | 6.1 | Yes | High |
| Project Mgmt. | CVE-2019-11994 | 9.8 | No | Critical |

Table 1 includes vulnerabilities associated with a first computer application, “Sales,” a second computer application, “HR,” and a third computer application, “Project Mgmt.” The “Sales” computer application includes vulnerability “CVE-2010-3782” and vulnerability “CVE-2016-3990.” The “HR” computer application includes vulnerability “CVE-2013-1420,” and the “Project Mgmt” computer applications includes vulnerability “CVE-2019-11994.” Table 1 also includes numerical and qualitative severity scores and RCE/PE indicators associated with each vulnerability.

While Table 1 includes RCE/PE indicator(s), in other embodiments in accordance with the disclosure, the organization may specify one or more different indicators associated with a computer application that indicates an increased likelihood of attack possibility and/or attack severity in the presence of the one or more indicators.

In accordance with certain embodiments, the vulnerability classifier 122 uses data of the assessment report 102 to generate a list of vulnerabilities. A non-limiting example, as shown in Table 2 below, includes the vulnerability classifier 122 modifying the severity score for a vulnerability of the list of vulnerabilities based on the RCE/PE indicator(s).

TABLE 2

| | | | | | Modified | |
|---|---|---|---|---|---|---|
| Computer | Vulnerability | Severity | | | Severity | Modified |
| Application | Identifier | Score | Severity | RCE/PE | Score | Severity |
| Sales | CVE-2010-3782 | 8.8 | High | No | 8.8 | High |
| | CVE-2016-3990 | 9.9 | Critical | No | 9.9 | Critical |
| HR | CVE-2013-1420 | 6.1 | Critical | Yes | 10 | Critical |
| Project Mgmt. | CVE-2019-11994 | 9.8 | Critical | No | 9.8 | Critical |

Table 2 includes the vulnerabilities identified in the assessment report 102 as well as modified severity scores, as determined by the vulnerability classifier 122. The “HR” computer application includes the vulnerability “CVE-2013-1420” having a modified severity score of “10,” in addition to the severity score of “6.1” assigned by the assessment report 102. In certain embodiments, in response to the RCE/PE indicator(s) indicating that an increased likelihood of attack possibility and/or attack severity is not present (i.e., “No”), the vulnerability classifier 122 outputs the severity score of the assessment report 102 as the Modified Severity Score. In response to the RCE/PE indicator(s) indicating that an increased likelihood of attack possibility and/or attack severity is present (i.e., “Yes”), the vulnerability classifier 122 increases the severity score of the assessment report 102 and outputs the result as the Modified Severity Score, the Modified Severity, or a combination thereof. In certain embodiments, one or more pieces of data of the list of vulnerabilities generated by the vulnerability classifier 122 is included in the remediation prioritization report 110.

In accordance with certain embodiments, the exploitability classifier 124 determines an

exploitability level for one or more vulnerabilities of the list of vulnerabilities generated by the vulnerability classifier 122. In non-limiting examples, the exploitability classifier 124 determines the exploitability level based on one or more intelligence feed 104. The intelligence feed 104 includes an internal threat data intelligence feed, an external threat data intelligence feed, or a combination thereof. The internal threat data intelligence feed is based on an organization's own data that was previously analyzed to define threats and attacks that target the organization. The external threat data intelligence feed includes a stream of globally defined threats that have known indicators. The external threat data intelligence feed further includes CVE scores, CVSS scores, or a combination thereof, for vulnerabilities identified in hacker channels (e.g., known information sites used by malicious third parties), actively exploited vulnerabilities, or a combination thereof.

Determining the exploitability level for the vulnerability of the list of vulnerabilities includes using one or more machine learning models. In a non-limiting example, the exploitability classifier 124 uses a machine learning model based on a clustering algorithm. The machine learning model may be a k-means model, a hierarchical clustering model, a Gaussian mixture model, or other model trained using an unsupervised learning clustering algorithm, for example. Using the machine learning model, the exploitability classifier 124 generates an attack possibility matrix, as shown below in Table 3.

TABLE 3

| Computer | | | |
|---|---|---|---|
| Application | Vulnerability | Clusters | Attack Possibility |
| Sales | CVE-2010-3782 | Yes | 1 |
| | CVE-2016-3990 | No | 0 |
| HR | CVE-2013-1420 | No | 0 |
| Project Mgmt. | CVE-2019-11994 | Yes | 1 |

Table 3 includes the list vulnerabilities associated with the computer applications, “Sales,” “HR,” and “Project Mgmt,” as well as whether the machine learning model used by the exploitability classifier 124 indicates that a vulnerability of the list of vulnerabilities includes one or more commonalities with data of the intelligence feed 104 (e.g., “Clusters”) and an attack possibility ranking (e.g., “Attack Possibility”) based on the machine learning model indicator.

In certain embodiments, the exploitability classifier 124 determines the exploitability level based on the attack possibility ranking, the modified severity score, or a combination thereof. In a non-limiting example, the exploitability classifier 124 determines the exploitability level indicates that a vulnerability is exploitable (e.g., “1”) in response to the attack possibility ranking indicating an attack is possible (e.g., “1”), a modified severity score indicating a value that is equivalent to or exceeds a specified threshold (e.g., “Critical”), or a combination thereof.

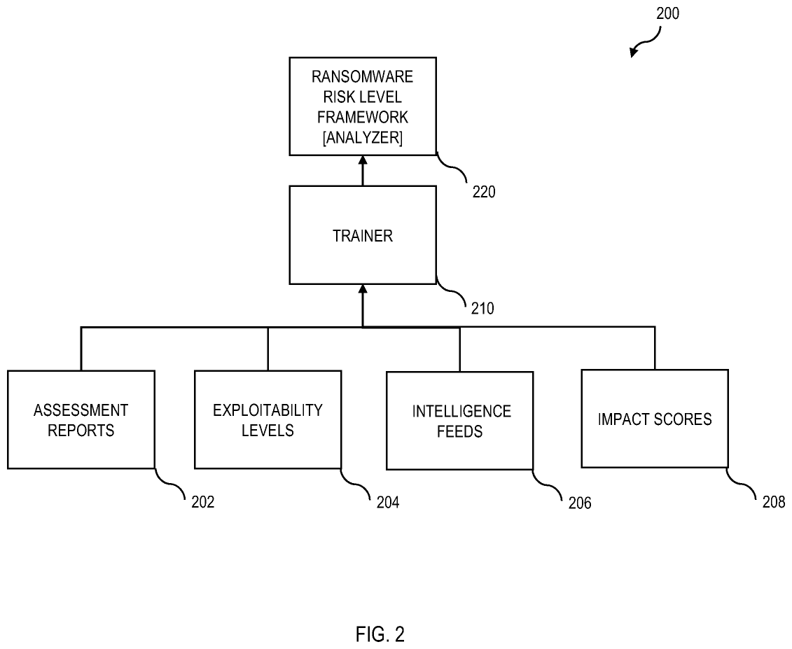

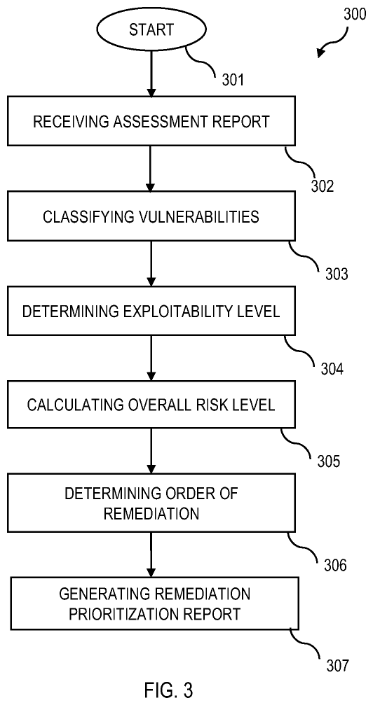

FIG. 2 is a block diagram of a training system 200 for training one or more machine learning models in accordance with certain embodiments. In a non-limiting example, the training system 200 is for training one or more machine learning models of a security tool for analyzing ransomware threat intelligence. A trainer 210 of the training system 200 receives inputs that include one or more of an assessment report 202, exploitability levels 204, intelligence feeds 206, or impact scores 208 and outputs one or more machine learning models used by an analyzer 220. In a non-limiting example, the analyzer 220 is a ransomware risk level framework as described with respect to FIG. 1 or 3.

The assessment report 202 includes data generated by one or more application scanners. The exploitability levels 204 include data of known ransomware exploits and associated vulnerabilities. The intelligence feeds 206 include an internal threat data intelligence feed, an external threat data intelligence feed, or a combination thereof. The impact scores 208 include data provided by the organization for evaluating the priority of computer applications used by the organization. The trainer 210 is used to train one or more machine learning models. The analyzer 220 uses the one or more machine learning models to evaluate a risk level of a computer application to ransomware, as previously described for certain embodiments.

The one or more machine learning models used by the analyzer 220 are trained by the trainer 210 using data for known threats including data associated with one or more of the assessment report 202, the exploitability levels 204, the intelligence feeds 206, and the impact scores 208. The trainer 210 may use a variety of machine learning methods to train the one or more machine learning models that are provided to the analyzer 220. The machine learning methods may include, but are not limited to, Logistic Regression (LR), Naïve Bayes (NB), K-Nearest Neighbor (KNN), Decision Tree (DT), Ada Boost (AB), Deep Neural Network (DNN), Random Forest (RF), K-means, hierarchical clustering, Gaussian mixtures, or other machine learning methods. Those skilled in the art will appreciate that the application of machine learning methods and machine learning models may include additional techniques and algorithms not expressly described herein without departing from the scope of this description.

In certain non-limiting examples, the system 100 includes the training system 200. The

assessment report 202 includes the assessment report 102. The exploitability levels 204 includes an exploitability level of the exploitability classifier 124. The intelligence feeds 206 include the intelligence feed 104. The impact scores 208 include the impact scores 106. The analyzer 220 is the analyzer 120. Using outputs of the analyzer 120 as inputs to the trainer 210 enables modification of the machine learning model used by the analyzer 120 as new ransomware threats are discovered.

Referring again to FIG. 1, in accordance with certain embodiments, the risk classifier 126 calculates a risk level for one or more vulnerabilities of the list of vulnerabilities generated by the vulnerability classifier 122 based on the exploitability level generated by the exploitability classifier 124. In a non-limiting example, risk classifier 126 also uses the modified severity score determined by the vulnerability classifier 122, the impact scores 106, or a combination thereof, to calculate the risk level for the one or more vulnerabilities. The risk classifier 126 calculates the risk level for each vulnerability of the list of vulnerabilities.

The impact scores 106 include one or more impact scores based on organization specific criteria. The one or more impact scores quantify an importance of a computer application to the organization's operations. Considering the impact scores 106 increases efficiency of remediation prioritization based on the organization's use of a computer application. In certain non-limiting examples, the one or more impact scores include an availability score, a confidentiality score, an integrity score, or a combination thereof. As a non-limiting example, a computer application may have greater uptime than other computer applications, which may result in the computer application having an increased availability score over other computer applications used by the organization. As another non-limiting example, a computer application may have highly sensitive data to be protected against any unauthorized access, which may result in the computer application having an increased confidentiality score over other computer applications used by the organization. As another non-limiting example, a computer application may have data that needs to be accurate and is to be protected against unauthorized modification, which may result in the computer application having an increased integrity score over other computer applications used by the organization.

The risk classifier 126 calculates an overall risk level for a computer application according to an equation which includes a risk level for at least one vulnerability of the list of vulnerabilities (as determined using the modified severity score determined by the vulnerability classifier 122 and an exploitability level for each vulnerability of the list of vulnerabilities as determined by the exploitability classifier 124) and which includes at least one impact score based on the impact scores 106. A non-limiting example equation which may be used is:

$$L = \frac{\frac{( S 1 \times E 1 ) + … ( Sn + E n )}{n} + C + I + A}{40} \times 100$$

where the computer application risk level, L, is calculated for n vulnerabilities, where S1 and E1 are the modified severity score and exploitability level, respectively, for the first vulnerability of the list of vulnerabilities, and Sn and En are the modified severity score and exploitability level, respectively, for the nth vulnerability of the list of vulnerabilities, and where C, I, and A, are impact scores, e.g., the confidentiality score, integrity score, and availability score, respectively.
A non-limiting example list of calculations regarding the computer application risk level is shown in Table 4 below, with each application referring to a different computer application evaluated. “CVE-2010-3782” is the first vulnerability for the sales application and “CVE-2016-3990” is the nth vulnerability for the sales application. Thus, for the “Sales Application” in the non-limiting example depicted in Table 4, n=2.

TABLE 4

| | | | | |
|---|---|---|---|---|
| | Modified | | | Overall |
| | Severity | Exploitability | Impact | Risk |
| Vulnerability | Score | Level | Score | Level |

Sales Application

| | | | | |
|---|---|---|---|---|
| CVE-2010- | 8.8 | 1 | C = 5 | 61 |
| 3782 | | | I = 5 | |
| CVE-2016- | 9.9 | 0 | A = 10 | |
| 3990 | | | | |

HR Application

| | | | | |
|---|---|---|---|---|
| CVE-2013- | 10 | 1 | C = 10 | 62.5 |
| 1420 | | | I = 5 | |
| | | | A = 0 | |

Project Mgmt. Application

| | | | | |
|---|---|---|---|---|
| CVE-2011- | 9.5 | 1 | C = 10 | 73.75 |
| 2609 | | | I = 5 | |
| | | | A = 5 | |

The system 100 may utilize remediation prioritizer 128 to calculate the order of remediation (i.e. the remediation priority) for one or more computer applications and generate the remediation prioritization report 110 based on the overall risk level for each computer application. A non-limiting example of the remediation prioritization report 110 is shown in Table 5 below.

TABLE 5

| Computer Application | Overall Risk Level | Remediation Priority |
|---|---|---|
| Sales | 61 | 3^{rd} |
| HR | 62.5 | 2^{nd} |
| Project Mgmt. | 73.75 | 1^{st} |

The system(s) described above may also be used to execute a method in accordance with certain embodiments described above. For example, FIG. 3 is a flow diagram of a method 300 for analyzing ransomware threat intelligence in accordance with certain embodiments. The method 300 includes evaluating a computer application by using the system 100 described above. The method 300 includes steps of starting (e.g., block 301), receiving an assessment report (e.g., block 302), identifying vulnerabilities (e.g., block 303), determining exploitability levels (e.g., block 304), calculating risk levels (e.g., block 305), determining remediation prioritization (e.g., block 306), and generating a remediation prioritization report (e.g., block 307).

The starting block 301, includes, but is not limited to, receiving an input from a user, the present system, another system, or a combination thereof, that indicates the present system is to perform the method 300. The assessment report block 302 includes the results of an application scanner. Identifying vulnerabilities block 303 includes using a vulnerability classifier to generate a list of vulnerabilities for one or more computer applications. Determining exploitability levels block 304 includes applying one or more machine learning models to determine the exploitability level for each vulnerability of the list of vulnerabilities. Calculating risk levels block 305 includes calculating an overall risk level for a computer application based on one or more vulnerabilities of the list of vulnerabilities, where the one or more vulnerabilities are associated with the computer application. Determining remediation prioritization block 306 includes determining an order of remediation for the computer applications based on the risk levels including the overall risk level for the computer application. Generating a remediation prioritization report block 307 includes evaluating the remediation priority from the remediation prioritizer and outputting a remediation prioritization report that enables the organization prioritize remediation of vulnerabilities based on the overall risk levels associated with the one or more computer applications.

Blocks 301, 302, 303, 304, 305, 306, and 307 may be executed for one or multiple computer applications. Blocks 301, 302, 303, 304, 305, 306, and 307 may be executed in any order, and in any combination, and may individually be executed one or more times. As a non-limiting example, block 301 may be executed one (1) time followed by execution of block 302, followed by four (4) executions of the sequence of blocks 304 then 303 then 305, further followed by execution of block 305 and subsequent execution of block 307 and then finally execution of block 306.

In accordance with certain embodiments, the method 300 includes determining a type of the remediation to determine a remediation priority for a computer application. The type of remediation is an action to be performed to prevent ransomware from accessing system resources. Non-limiting examples of the type of remediation include patching the computer application, blocking the computer application, or another action that prevents ransomware from accessing system resources. Blocking the computer application may include disabling user access to the computer application until a patch is available, blocking the computer application from accessing system resources, or another action that prevents ransomware from accessing system resources. The method 300 includes determining a first type of remediation associated with a first computer application of the remediation prioritization report, determining a second type of remediation associated with a second computer application of the remediation prioritization report, and adjusting a first priority for the first computer application and a second priority for the second computer application based on the first type of remediation and the second type of remediation. The method 300 may adjust the first priority and the second priority before outputting the remediation prioritization report or may output a second remediation prioritization report with the adjusted priorities.

System 100, training system 200, and method 300 may each be partially or wholly implemented, in any combination, as part of a security tool or multiple security tools used by an organization for combating ransomware threats or cybersecurity threats generally.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory

that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

FIG. 4 is a block diagram of a computer system that can be employed to execute a system for analyzing ransomware threat intelligence in accordance with certain embodiments described. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus

406 that couples various system components, including the system memory 404, to processing unit 402. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 410, including operating system 432, one or more computer application programs 434, other program modules 436, and program data 438. In some examples, the computer application programs 434 can include the ransomware risk level framework 120, 220 (i.e. the analyzer 120, 220) and the trainer 210, and the program data 338 can include the assessment report 102, 202, the intelligence feed 104, 206, the impact scores 106, 208, the list of vulnerabilities determined by the vulnerability classifier 122, the attack vulnerability matrix or the exploitability level determined by the exploitability classifier 124, the computer application overall risk level determined by the risk classifier 126, the order of remediation determined by the remediation prioritizer 128, and the remediation prioritization report 110. The computer application programs 434 and program data 438 can include functions and methods programmed to perform the method 300 to generate the remediation prioritization report 110, such as shown and described herein.

A user may enter commands and information into computer system 400 through one or more input devices 440, such as a pointing device (e.g., a mouse, touch screen), keyboard, microphone, joystick, game pad, scanner, and the like. For instance, the user can employ input device 440 to edit or modify the ransomware risk level framework (i.e. the analyzer) 120, 220, the one or more machine learning models, and/or the impact scores 106, 208. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and a wide area network (WAN). When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, computer application programs 434 or program data 438 depicted relative to computer system 400, or portions thereof, may be stored in a remote memory storage device 454.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the description has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the description without departing from the essential scope thereof. Therefore, it is intended that the invention not be limited to the particular embodiments described, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A security tool comprising:
a vulnerability classifier for classifying vulnerabilities based on an assessment report;
an exploitability classifier for determining an exploitability level for a vulnerability of a list of vulnerabilities of the assessment report based on data of an intelligence feed;
a risk classifier for calculating an overall risk level for a computer application associated with the vulnerability of the list of vulnerabilities based on an impact score for the computer application; and
a remediation prioritizer to determine an order of remediation for the computer application and to generate a remediation prioritization report including the order of remediation.

2. The security tool of claim 1, wherein the list of vulnerabilities includes a severity score for the vulnerability of the list of vulnerabilities.

3. The security tool of claim 1, wherein determining the exploitability level for the vulnerability of the list of vulnerabilities comprises:
analyzing the vulnerability of the list of vulnerabilities to determine whether the vulnerability includes one or more commonalities of the vulnerability with the data of the intelligence feed; and
generating the exploitability level for the vulnerability of the list of vulnerabilities based on a result of the analysis.

4. The security tool of claim 3, wherein determining the exploitability level for the vulnerability of the list of vulnerabilities further comprises applying one or more machine learning models to identify the one or more commonalities of the vulnerability with the data of the intelligence feed.

5. The security tool of claim 3, wherein determining the exploitability level for the vulnerability of the list of vulnerabilities further comprises:
generating an attack possibility matrix based on the result of the analysis; and
generating the exploitability level for the vulnerability of the list of vulnerabilities based on at least one of the attack possibility matrix, a modified severity score, or a combination thereof.

6. The security tool of claim 5, further comprising determining the modified severity score based on a remote code execution indicator for the vulnerability of the list of vulnerabilities, a privilege escalation indicator for the vulnerability of the list of vulnerabilities, or a combination thereof.

7. The security tool of claim 1, wherein the data of the intelligence feed comprises an internal threat data intelligence feed, an external threat data intelligence feed, or a combination thereof.

8. The security tool of claim 1, wherein the impact score for the computer application comprises a confidentiality score, an integrity score, an availability score, or a combination thereof.

9. A method comprising:
classifying vulnerabilities based on an assessment report;
determining an exploitability level for a vulnerability of a list of vulnerabilities based on data of an intelligence feed;
calculating an overall risk level for a computer application associated with the vulnerability of the list of vulnerabilities based on an impact score for the computer application; and
determining an order of remediation for the computer application; and
generating a remediation prioritization report including the order of remediation for the computer application.

10. The method of claim 9, wherein the list of vulnerabilities includes a severity score for the vulnerability of the list of vulnerabilities.

11. The method of claim 9, wherein determining the exploitability level for the vulnerability of the list of vulnerabilities comprises:
analyzing, using one or machine learning models, the vulnerability of the list of vulnerabilities to determine whether the vulnerability includes one or more commonalities with the data of the intelligence feed; and
generating the exploitability level for the vulnerability of the list of vulnerabilities based on a result of the analysis.

12. The method of claim 11, wherein determining the exploitability level for the vulnerability of the list of vulnerabilities further comprises:
generating an attack possibility matrix based on the result of the analysis; and
generating the exploitability level for the vulnerability of the list of vulnerabilities based on at least one of the attack possibility matrix, a modified severity score, or a combination thereof.

13. The method of claim 12, further comprising determining the modified severity score based on a remote code execution indicator for the vulnerability of the list of vulnerabilities, a privilege escalation indicator for the vulnerability of the list of vulnerabilities, or a combination thereof.

14. The method of claim 9, wherein the data of the intelligence feed comprises an internal threat data intelligence feed, an external threat data intelligence feed, or a combination thereof.

15. The method of claim 9, wherein the impact score for the computer application comprises a confidentiality score, an integrity score, an availability score, or a combination thereof.
